(19) United States
(12) Patent Application Publication
(10) Pub. No.: US 2026/0303661 A1
(43) Pub. Date: Oct. 1, 2026

(54) PRIORITY DETERMINATION SYSTEM AND PRIORITY DETERMINATION METHOD

(71) Applicant: Panasonic Automotive Systems Co., Ltd., Kanagawa (JP)

(72) Inventors: Ryo WATANABE, Osaka (JP); Tomoyuki HAGA, Nara (JP); Yuishi TORISAKI, Osaka (JP); Shoichiro SEKIYA, Osaka (JP); Toru IWANO, Osaka (JP)

(73) Assignee: Panasonic Automotive Systems Co., Ltd., Kanagawa (JP)

(21) Appl. No.: 19/430,916

(22) Filed: Dec. 23, 2025

(30) Foreign Application Priority Data
Mar. 27, 2025 (JP) 2025-054017

(51) Int. Cl. H04L 9/40

(52) U.S. Cl. CPC H04L 63/1491; H04L 63/1416; H04L 63/1433

(57) ABSTRACT

A priority determination system includes: a collaborator that collaborates with a honeypot to obtain attack information indicating a detail of a cyberattack on the honeypot and security information indicating a security level of the honeypot, the honeypot including a software configuration that is identical to at least part of a configuration of a monitoring target system; a determiner that determines, based on the attack information and the security information, a countermeasure priority that is a priority of countermeasure processing that addresses a vulnerability in the monitoring target system, the vulnerability having been exploited for the cyberattack; and an outputter that outputs the countermeasure priority determined.

### CROSS REFERENCE TO RELATED APPLICATION

The present application is based on and claims priority of Japanese Patent Application No. 2025-054017 filed on Mar. 27, 2025.

### FIELD

The present disclosure relates to a priority determination system and the like that determine a priority for a vulnerability.

### BACKGROUND

Recent years have seen the rapid evolution of automobile functions. Examples of the functions include external connection, autonomous driving, automatic control, and in-vehicle infotainment (IVI). The evolution of the functions, the integration of electronic control units (ECUs), the development of software defined vehicles (SDVs), and other similar factors make it more important to address security risks in automobiles. As a countermeasure against the security risk, there is countermeasure processing that addresses a vulnerability in a monitoring target system, such as an ECU. Here, for example, the average number of reported vulnerabilities is 108 per day, and it is difficult to determine vulnerabilities to be preferentially subjected to the countermeasure processing out of all of the reported vulnerabilities.

Patent Literature 1 (PTL 1) proposes a network monitoring device that calculates, based on the presence of a log about a cyberattack on a honeypot, an assessment value indicating a priority for a countermeasure against the cyberattack. The priority for the cyberattack can be considered as a priority of countermeasure processing that addresses a vulnerability exploited for the cyberattack. The log indicates, for example, whether the honeypot has received a cyberattack. That is, the network monitoring device according to PTL 1 determines a priority of countermeasure processing that addresses a vulnerability, based on, for example, whether a honeypot has received a cyberattack. Determining such a priority for each vulnerability enables a vulnerability that should be preferentially subjected to the countermeasure processing to be found easily.

### CITATION LIST

### Patent Literature

PTL 1: Japanese Patent No. 7311354

### SUMMARY

Unfortunately, the network monitoring device according to PTL 1 described above can be improved upon.

Hence, the present disclosure provides a priority determination system and the like capable of improving upon the above related art.

A priority determination system according to an aspect of the present disclosure includes: a collaborator that collaborates with a honeypot to obtain attack information indicating a detail of a cyberattack on the honeypot and security information indicating a security level of the honeypot, the honeypot including a software configuration that is identical to at least part of a configuration of a monitoring target system; a determiner that determines, based on the attack information and the security information, a countermeasure priority that is a priority of countermeasure processing that addresses a vulnerability in the monitoring target system, the vulnerability having been exploited for the cyberattack; and an outputter that outputs the countermeasure priority determined.

Note that such general or specific aspect may be implemented to a device, a method, an integrated circuit, a computer program, or a computer-readable recording medium such as a compact disc read-only memory (CD-ROM), or any combination of them. The recording medium may be a non-transitory recording medium.

The priority determination system according to the present disclosure is capable of improving upon the above related art.

Further merits and advantageous effects of one aspect of the present disclosure will become apparent from the following description and drawings. These merits and/or advantageous effects are provided by the elements described in the following embodiments, description, and drawings. However, not all of such elements are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram for describing the overview of a processing operation by a priority determination system in Embodiment 1.

FIG. 2 is a diagram illustrating an example of the functional configuration of the priority determination system in Embodiment 1.

FIG. 3 is a table showing an example of individual increments for determining a countermeasure priority in Embodiment 1.

FIG. 4 is a diagram illustrating an example of a success or a failure of a cyberattack in accordance with a progression in the cyber kill chain in Embodiment 1.

FIG. 5 is a diagram illustrating an example of a success or a failure of a cyberattack exploiting a vulnerability in Embodiment 1.

FIG. 6 is a flowchart illustrating an example of a processing operation by the priority determination system in Embodiment 1.

FIG. 7 is a diagram for describing the overview of a processing operation by a priority determination system in Embodiment 2.

FIG. 8 is a diagram illustrating an example of the functional configuration of the priority determination system in Embodiment 2.

FIG. 9 is a flowchart illustrating an example of a processing operation by the priority determination system in Embodiment 2.

### DESCRIPTION OF EMBODIMENTS

A priority determination system according to a first aspect of the present disclosure includes: a collaborator that collaborates with a honeypot to obtain attack information indicating a detail of a cyberattack on the honeypot and security information indicating a security level of the honeypot, the honeypot including a software configuration that is identical to at least part of a configuration of a monitoring target system; a determiner that determines, based on the attack information and the security information, a countermeasure priority that is a priority of countermeasure processing that addresses a vulnerability in the monitoring target system, the vulnerability having been exploited for the cyberattack; and an outputter that outputs the countermeasure priority determined.

Accordingly, the countermeasure priority is determined based on the detail of the cyberattack exploiting the vulnerability of the monitoring target system and the security level of the honeypot receiving the cyberattack. Accordingly, the countermeasure priority can be determined with higher accuracy than a countermeasure priority that is determined based on whether a cyberattack has occurred. That is, it becomes possible to increase the accuracy of a countermeasure priority determined for a vulnerability.

In short, a countermeasure priority, which is the priority determined by the network monitoring device according to PTL 1 described above, is low in accuracy. Hence, the present disclosure provides a priority determination system and the like capable of increasing the accuracy of a countermeasure priority determined for a vulnerability.

The priority determination system according to a second aspect of the present disclosure may further include: an obtainer that obtains alert information for notification of the vulnerability found in the monitoring target system; and an attack analyzer that analyzes the attack information to generate attack success/failure information indicating whether the cyberattack has been a success or a failure, wherein when the obtainer obtains the alert information, the collaborator makes an inquiry to a plurality of honeypots having mutually different security levels to obtain the attack information and the security information of each of the plurality of honeypots, the plurality of honeypots each being the honeypot, and the determiner determines the countermeasure priority for the vulnerability for which the notification is made in the alert information, based on the attack success/failure information and the security information of each of the plurality of honeypots as inquiry destinations. Note that the second aspect may depend from the first aspect.

The countermeasure priority for the vulnerability is thus determined in response to obtaining the alert information, that is, finding the vulnerability in the monitoring target system, as a trigger. In this event, the pieces of attack success/failure information about the found vulnerability and the pieces of security information are collected through the inquiry to the plurality of honeypots and used to determine the countermeasure priority. That is, a success or a failure of each of cyberattacks and the security levels are used to determine the countermeasure priority. Thus, at the timing when the vulnerability is found, the countermeasure priority for the vulnerability can be determined appropriately with high accuracy.

It is possible, in the priority determination system according to a third aspect of the present disclosure, that the determiner: derives an increment for a risk value of the vulnerability, based on the attack success/failure information and the security information of each of the plurality of honeypots as the inquiry destinations; updates the risk value by adding the increment derived to the risk value associated with the vulnerability; and determines, as the countermeasure priority for the vulnerability, a higher countermeasure priority as the risk value updated is greater. Note that the third aspect may depend from the second aspect. The risk value associated with the vulnerability may be a risk value derived by a different system.

Thus, for example, in a case in which the vulnerability is found, a higher countermeasure priority can be determined for the vulnerability as the number of cyberattacks exploiting the vulnerability is larger, the number of successful cyberattacks out of the cyberattacks is larger, or the security levels of honeypots having received the cyberattacks are higher. As a result, the accuracy of the countermeasure priority can be further increased.

It is possible, in the priority determination system according to a fourth aspect of the present disclosure, that the determiner: derives, for each of the plurality of honeypots as the inquiry destinations, an individual increment corresponding to a combination of the attack success/failure information and the security information of the honeypot; and derives the increment by calculating a sum of the individual increments of the plurality of honeypots. Note that the fourth aspect may depend from the third aspect.

The sum of the individual increments is thus derived as the increment, enabling the derivation of an appropriate increment for the vulnerability.

It is possible, in the priority determination system according to a fifth aspect of the present disclosure, that the determiner derives a first individual increment and a second individual increment each being the individual increment, the second individual increment being greater than the first individual increment, the first individual increment is the individual increment corresponding to a combination of (i) the attack success/failure information indicating that the cyberattack has been a failure and (ii) the security information indicating a certain security level, and the second individual increment is the individual increment corresponding to a combination of (i) the attack success/failure information indicating that the cyberattack has been a success and (ii) the security information indicating the certain security level. Note that the fifth aspect may depend from the fourth aspect.

Thus, in a case in which the attack success/failure information indicates that the cyberattack has been a success, a great individual increment can be derived and reflected in the increment, and in a case in which the attack success/failure information indicates that the cyberattack has been a failure, a small individual increment can be derived and reflected in the increment. As a result, an appropriate countermeasure priority that matches the detail of a cyberattack can be determined.

It is possible, in the priority determination system according to a sixth aspect of the present disclosure, that the determiner derives, as the individual increment corresponding to the combination, a greater individual increment as the security level indicated by the security information included in the combination is higher. Note that the sixth aspect may depend from the fourth aspect or the fifth aspect.

Thus, as the security level of the honeypot is higher, a great individual increment can be derived and reflected in the increment. As a result, an appropriate countermeasure priority can be determined.

The priority determination system according to a seventh aspect of the present disclosure may further include: an attack analyzer that analyzes the attack information to generate (i) attack success/failure information indicating whether the cyberattack is a success or a failure and (ii) attack feature information indicating a feature of the cyberattack; and a vulnerability identification unit that identifies, based on the attack feature information, the vulnerability exploited for the cyberattack, wherein when, for each of the plurality of honeypots having the mutually different security levels, the attack information and the security information of the honeypot are transmitted to the collaborator each time the honeypot receives the cyberattack, each time the collaborator obtains the attack information and the security information, the determiner determines the countermeasure priority for the vulnerability identified by the vulnerability identification unit, based on the security information and the attack success/failure information generated from the attack information. Note that the seventh aspect may depend from the first aspect.

Thus, the obtaining of the attack information and the security information by the collaborator, that is, the reception of a cyberattack by the honeypot, serves as a trigger to determine the countermeasure priority for the vulnerability exploited for the cyberattack. In this event, the attack success/failure information about the vulnerability exploited for the cyberattack and the security information are used to determine the countermeasure priority. That is, a success or a failure of the cyberattack and the security level are used to determine the countermeasure priority. Thus, at the timing when the honeypot receives the cyberattack, the countermeasure priority for the vulnerability exploited for the cyberattack can be determined appropriately with high accuracy.

It is possible, in the priority determination system according to an eighth aspect, that each time the collaborator obtains the attack information and the security information, the determiner: derives an individual increment for a risk value of the vulnerability, based on the security information and the attack success/failure information generated from the attack information; updates the risk value by adding the individual increment derived to a most recent risk value associated with the vulnerability; and determines, as the countermeasure priority for the vulnerability, a higher countermeasure priority as the risk value updated is greater. Note that the eighth aspect may depend from the seventh aspect.

Thus, each time the honeypot receives the cyberattack, for example, in a case in which the security level of the honeypot is high and the cyberattack has been a success, a high countermeasure priority can be determined for the vulnerability exploited for the cyberattack. As a result, the accuracy of the countermeasure priority can be further increased.

It is possible, in the priority determination system according to a ninth aspect of the present disclosure, that the determiner derives the individual increment to be greater in a first case than in a second case, the first case is a case in which the attack success/failure information indicates that the cyberattack has been a success and the security information indicates a certain security level, and the second case is a case in which the attack success/failure information indicates that the cyberattack has been a failure and the security information indicates the certain security level. Note that the ninth aspect may depend from the eighth aspect.

Thus, in a case in which the attack success/failure information indicates that the cyberattack has been a success, a great individual increment can be derived and reflected in a risk value, and in a case in which the attack success/failure information indicates that the cyberattack has been a failure, a small individual increment can be derived and reflected in the risk value. As a result, an appropriate countermeasure priority that matches the detail of a cyberattack can be determined.

It is possible, in the priority determination system according to a tenth aspect of the present disclosure, that the determiner derives, as the individual increment, a greater individual increment as the security level indicated by the security information is higher. Note that the tenth aspect may depend from the eighth aspect or the ninth aspect.

Thus, as the security level of the honeypot is higher, a great individual increment can be derived and reflected in a risk value. As a result, an appropriate countermeasure priority can be determined.

A priority determination method according to an eleventh aspect of the present disclosure is executed by a computer and includes: collaborating with a honeypot to obtain attack information indicating a detail of a cyberattack on the honeypot and security information indicating a security level of the honeypot, the honeypot including a software configuration that is identical to at least part of a configuration of a monitoring target system; determining, based on the attack information and the security information, a countermeasure priority that is a priority of countermeasure processing that addresses a vulnerability in the monitoring target system, the vulnerability having been exploited for the cyberattack; and outputting the countermeasure priority determined.

It is thus possible to provide the same advantageous effects as with the priority determination system according to the first aspect.

Hereinafter, certain exemplary embodiments are described in greater detail with reference to the accompanying Drawings.

The exemplary embodiments described below show general or specific examples. The numerical values, shapes, materials, elements, the arrangement and connection of the elements, steps, the processing order of the steps, etc. shown in the following exemplary embodiments are mere examples, and therefore do not limit the scope of the present disclosure. Therefore, among the elements in the following exemplary embodiments, those not recited in any one of the independent claims are described as optional elements.

Also note that the drawings are schematic diagrams, and thus they are not always exactly illustrated. Also, the same elements are assigned the same reference marks throughout the drawings.

### Embodiment 1

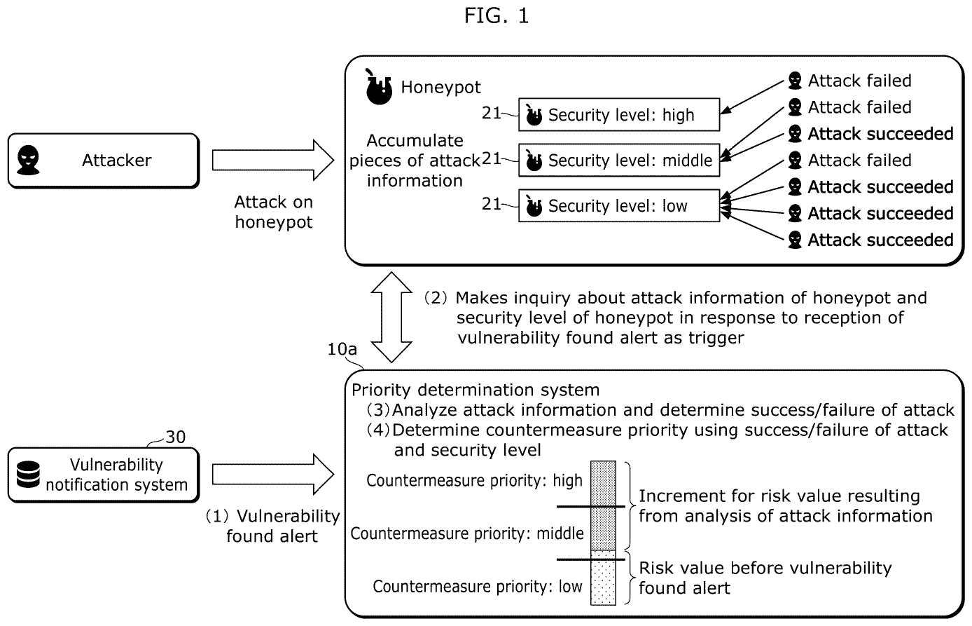

FIG. 1 is a diagram for describing the overview of a processing operation by a priority determination system in the present embodiment.

Priority determination system 10a in the present embodiment is a system that determines, as a countermeasure priority, the priority of countermeasure processing that addresses each of vulnerabilities in a monitoring target system. Priority determination system 10a collaborates with a plurality of honeypots 21. The monitoring target system is, for example, an ECU. Honeypots 21 may be deployed in the cloud.

Each of honeypots 21 includes a software configuration that is identical to at least part of the configuration of the monitoring target system. Honeypots 21 have mutually different security levels. The security levels are levels of security (specifically, cybersecurity). Each of the security levels is, for example, high, middle, or low. A higher security level indicates that honeypot 21 with the security level is less likely to receive a cyberattack.

One or more attackers make cyberattacks on the respective honeypots 21. Note that the cyberattacks are also simply referred to as attacks. As a result, pieces of attack information indicating the details of the cyberattacks made on the respective honeypots 21 are accumulated.

As such pieces of attack information are accumulated, steps (1) to (4) shown below are executed in order. First, in step (1), in a case in which vulnerability notification system 30 finds a vulnerability in the monitoring target system, vulnerability notification system 30 puts out an alert for notification of the found vulnerability (i.e., a vulnerability found alert) to priority determination system 10a. Next, in step (2), in response to the vulnerability found alert received, as a trigger, priority determination system 10a makes an inquiry to honeypots 21. By the inquiry, priority determination system 10a obtains pieces of attack information and pieces of security information of honeypots 21. The pieces of attack information indicate the details of the cyberattacks on honeypots 21 that exploit the above-described vulnerability. The pieces of security information indicate the security levels of honeypots 21.

Next, in step (3), priority determination system 10a analyzes the obtained pieces of attack information to determine a success or a failure of each of the cyberattacks. That is, based on the pieces of attack information, priority determination system 10a determines whether a cyberattack on honeypot 21 corresponding to each of the pieces of attack information has been a success or a failure. Then, in step (4), priority determination system 10a determines a countermeasure priority that is the priority of countermeasure processing that addresses the vulnerability of which the notification has been made with the vulnerability found alert. In this determination, priority determination system 10a determines the countermeasure priority using a success/failure in each of the attacks on honeypots 21 and the security levels of honeypots 21.

For example, to determine the countermeasure priority, priority determination system 10a derives an increment for a risk value based on the success/failure in each of the cyberattacks on honeypots 21 and the security levels of honeypots 21. Priority determination system 10a next updates the risk value by adding the increment to the risk value associated with the above-described vulnerability, that is, the risk value that has already been set before the vulnerability found alert. Priority determination system 10a then determines the countermeasure priority based on the updated risk value (i.e., the risk value after the update). As a specific example, priority determination system 10a determines the countermeasure priority “low” in a case in which the risk value after the update is less than or equal to a first threshold, determines the countermeasure priority “middle” in a case in which the risk value after the update is greater than the first threshold and less than or equal to a second threshold, and determines the countermeasure priority “high” in a case in which the risk value after the update is greater than the second threshold. Note that the second threshold is a value greater than the first threshold.

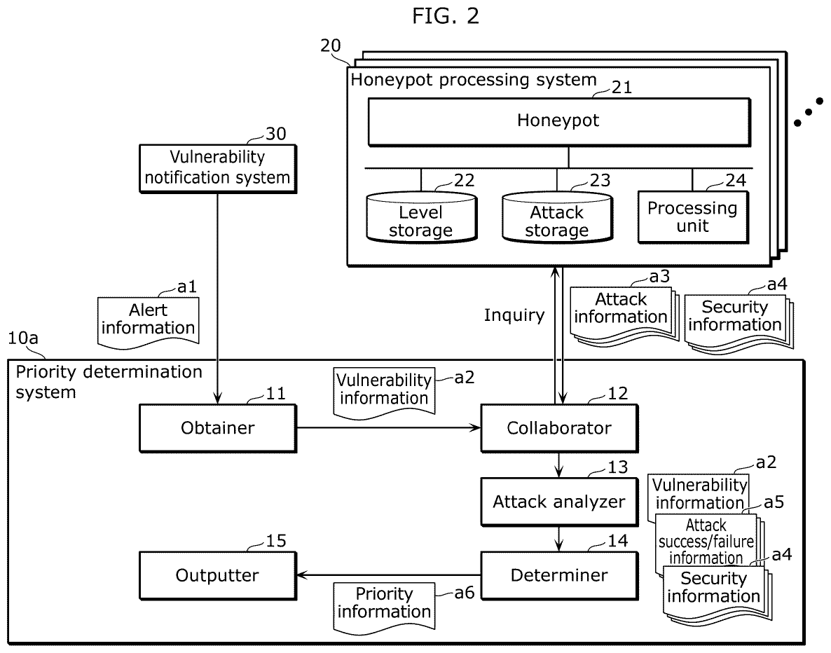

FIG. 2 is a diagram illustrating an example of the functional configuration of priority determination system 10a in the present embodiment.

Priority determination system 10a in the present embodiment includes obtainer 11, collaborator 12, attack analyzer 13, determiner 14, and outputter 15.

Obtainer 11 obtains alert information a1 from vulnerability notification system 30. Alert information a1 is information that is transmitted from vulnerability notification system 30 to priority determination system 10a in the above-described vulnerability found alert. Alert information a1 indicates a vulnerability and the like in the monitoring target system. That is, obtainer 11 obtains alert information a1 for notification of the vulnerability found in the monitoring target system. Obtainer 11 then outputs vulnerability information a2, which is information for discerning the vulnerability of which the notification has been made with alert information a1, to collaborator 12. For example, vulnerability information a2 indicates common vulnerabilities and exposures (CVE)-ID included in alert information a1. Obtainer 11 may extract vulnerability information a2 from alert information a1.

Obtaining vulnerability information a2 from obtainer 11, collaborator 12 makes an inquiry to a plurality of honeypot processing systems 20 (i.e., honeypots 21). Each of honeypot processing systems 20 includes honeypot 21, level storage 22, attack storage 23, and processing unit 24. As described above, each of honeypots 21 includes the software configuration that is identical to at least part of the configuration of the monitoring target system (e.g., the configuration from which a security-related configuration is excluded), and honeypots 21 have mutually different security levels. The security levels are adjusted using on/off settings, strength settings, or the like of firewalls provided in honeypots 21. Level storage 22 is a recording medium storing security information a4 indicating the security level of honeypot 21 that is provided in honeypot processing system 20 together with level storage 22. Attack storage 23 is a recording medium storing attack information a3 indicating the detail of a cyberattack on honeypot 21 that is provided in honeypot processing system 20 together with attack storage 23. Processing unit 24 monitors honeypot 21 that is provided in honeypot processing system 20 together with processing unit 24. In a case in which a cyberattack is made on honeypot 21, processing unit 24 generates attack information a3 indicating the detail of the cyberattack and stores attack information a3 in attack storage 23. Attack information a3 indicates, for example, the log of a cyberattack. For example, attack information a3 indicates when, how, and in what order an attack is made on constituent components included in honeypot 21 such as a system and software, in the form of a log.

In the above-described inquiry, for example, collaborator 12 makes an inquiry to each of honeypot processing systems 20 as to whether there is attack information a3 about a cyberattack exploiting any vulnerability indicated in vulnerability information a2. Receiving the inquiry, processing unit 24 of each honeypot processing system 20 determines whether attack information a3 is stored in attack storage 23. In a case in which processing unit 24 determines that attack information a3 is stored in attack storage 23, processing unit 24 transmits attack information a3 and security information a4 stored in level storage 22 to collaborator 12. In a case in which a plurality of pieces of attack information a3 satisfying the above-described inquiry are stored in attack storage 23, processing unit 24 transmits the pieces of attack information a3 to collaborator 12. As a result, collaborator 12 obtains one or more pieces of attack information a3 and one or more pieces of security information a4 from each of one or more honeypot processing systems 20 of honeypot processing systems 20. Collaborator 12 then outputs the obtained one or more pieces of attack information a3 and one or more pieces of security information a4, and vulnerability information a2 to attack analyzer 13.

In this manner, collaborator 12 in the present embodiment collaborates with each honeypot 21 to obtain attack information a3 indicating the detail of a cyberattack on honeypot 21 and security information a4 indicating the security level of honeypot 21.

Obtaining the one or more pieces of attack information a3, the one or more pieces of security information a4, and vulnerability information a2 from collaborator 12, attack analyzer 13 analyzes each of the one or more pieces of attack information a3. Specifically, for each of the one or more pieces of attack information a3, attack analyzer 13 determines whether a cyberattack has been a success or a failure, that is, the success/failure of the cyberattack, based on the detail of the cyberattack indicated in the piece of attack information a3. Then, for each of the one or more pieces of attack information a3, attack analyzer 13 generates information indicating the success/failure of the cyberattack determined through the analysis of the piece of attack information a3, as one or more pieces of attack success/failure information a5. In this manner, attack analyzer 13 in the present embodiment analyzes attack information a3 to generate attack success/failure information a5 indicating whether a cyberattack has been a success or a failure. Attack analyzer 13 then outputs the one or more pieces of attack success/failure information a5, the one or more pieces of security information a4, and vulnerability information a2 to determiner 14.

Obtaining the one or more pieces of attack success/failure information a5, the one or more pieces of security information a4, and vulnerability information a2 from attack analyzer 13, determiner 14 determines a countermeasure priority that is the priority of countermeasure processing that addresses a vulnerability indicated in vulnerability information a2. In this determination, determiner 14 derives, for each piece of attack success/failure information a5, an individual increment using the success/failure of the cyberattack indicated in the piece of attack success/failure information a5 and the security level indicated in the piece of security information a4 corresponding to the piece of attack success/failure information a5. Note that the piece of security information a4 corresponding to the piece of attack success/failure information a5 is information corresponding to the piece of attack information a3 used to generate the piece of attack success/failure information a5. That is, the piece of security information a4 is information indicating the security level of honeypot 21 included in honeypot processing system 20 that has output the piece of attack information a3.

Determiner 14 then calculates the sum of the individual increment derived for each piece of attack success/failure information a5, as an increment for a risk value. Determiner 14 next updates a risk value associated with the vulnerability indicated in vulnerability information a2 by adding the calculated increment to the risk value, as described above. Note that the risk value associated with the vulnerability is, for example, a value derived by another system. The risk value is a value derived from a common vulnerability scoring system (CVSS) score, an attack occurrence probability, or the like. Determiner 14 then determines the countermeasure priority by comparing the risk value after the update with the first threshold and the second threshold. Determiner 14 generates priority information a6 that indicates the determined countermeasure priority and the above-described vulnerability in association with each other and outputs priority information a6 to outputter 15.

In this manner, determiner 14 in the present embodiment determines, based on attack information a3 and security information a4, a countermeasure priority that is the priority of countermeasure processing addressing a vulnerability of the monitoring target system that has been exploited for a cyberattack.

Obtaining priority information a6 described above from determiner 14, outputter 15 outputs priority information a6 to the outside of priority determination system 10a. That is, outputter 15 in the present embodiment outputs the determined countermeasure priority.

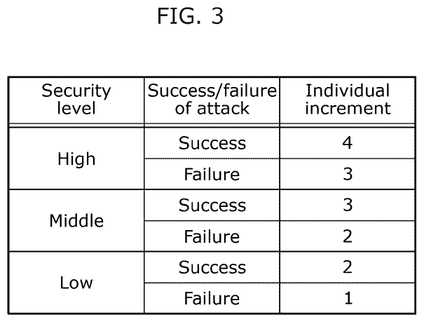

FIG. 3 is a table showing an example of individual increments for determining a countermeasure priority.

To derive an individual increment, determiner 14 refers to, for example, the table shown in FIG. 3, to specify an individual increment that is associated with the security level indicated in security information a4 and the success/failure of the cyberattack indicated in attack information a3. The individual increment is thus derived.

For example, determiner 14 derives the individual increment “4” for the security level “high” and the success/failure of cyberattack “success”. Determiner 14 derives the individual increment “3” for the security level “high” and the success/failure of cyberattack “failure” and the security level “middle” and the success/failure of cyberattack “success”. Determiner 14 derives the individual increment “2” for the security level “middle” and the success/failure of cyberattack “failure” and the security level “low” and the success/failure of cyberattack “success”. Further, determiner 14 derives the individual increment “1” for the security level “low” and the success/failure of cyberattack “failure”.

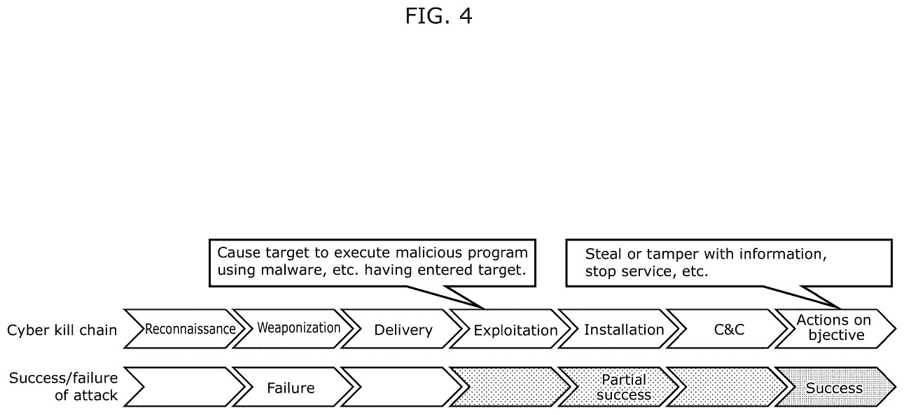

FIG. 4 is a diagram illustrating an example of a success or a failure of a cyberattack in accordance with a progression in the cyber kill chain.

Attack analyzer 13 may determine the success/failure of a cyberattack based on the cyber kill chain. The cyber kill chain indicates a series of actions from the determination of a target by an attacker to the achievement of a goal by an actual attack, step by step. For example, in a case in which a cyberattack has progressed as far as any one of the actions including reconnaissance, weaponization, and delivery, attack analyzer 13 determines a failure as the success/failure of the cyberattack. In a case in which a cyberattack has progressed as far as any one of the actions including exploitation, installation, C&C (command & control), and actions on objective, attack analyzer 13 determines a success as the success/failure of the cyberattack.

Note that, in a case in which a cyberattack has progressed as far as any one of the actions including exploitation, installation, and C&C (command & control), attack analyzer 13 may determine a partial success as the success/failure of the cyberattack, and in a case in which a cyberattack has progressed to actions on objective, attack analyzer 13 may determine success as the success/failure of the cyberattack. In this case, determiner 14 can derive a more detailed individual increment using partial success in addition to success and failure.

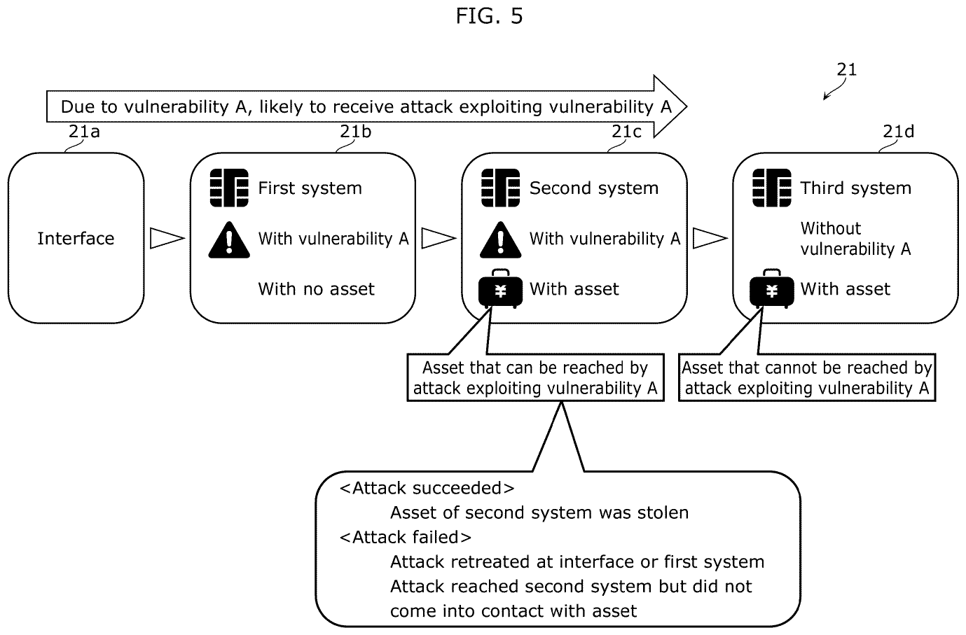

FIG. 5 is a diagram illustrating an example of a success or a failure of a cyberattack exploiting a vulnerability.

For example, honeypot 21 includes interface 21a, first system 21b, second system 21c, and third system 21d. Interface 21a is an input interface from the outside to the inside of honeypot 21. First system 21b has vulnerability A and possesses no asset such as data. Second system 21c has vulnerability A and possesses an asset. This asset is an asset that can be reached by a cyberattack exploiting vulnerability A. Third system 21d does not have vulnerability A and possesses an asset. This asset is an asset that cannot be reached by a cyberattack exploiting vulnerability A. That is, since first system 21b and second system 21c have vulnerability A, the range from interface 21a to second system 21c can be attacked by the cyberattack exploiting vulnerability A.

In a case in which attack analyzer 13 grasps that, for example, the asset of second system 21c was stolen by the cyberattack as a result of analyzing pieces of attack information a3 on honeypots 21 as described above, attack analyzer 13 determines a “success” as the success/failure of the cyberattack. In a case in which attack analyzer 13 grasps that, for example, the cyberattack reached interface 21a or first system 21b but retreated there as a result of analyzing the pieces of attack information a3, attack analyzer 13 determines a “failure” as the success/failure of the cyberattack. In a case in which attack analyzer 13 grasps that, for example, the cyberattack reached second system 21c but did not come into contact with the asset of second system 21c, as a result of analyzing the pieces of attack information a3, attack analyzer 13 determines a “failure” as the success/failure of the cyberattack.

In a case in which the cyberattack altered or gained at least one of functions, such as encrypting confidential information included in honeypot 21 or gaining an administrator privilege, attack analyzer 13 may determine a “success” as the success/failure of the cyberattack. In a case in which the cyberattack did not come into contact with the function or the asset, attack analyzer 13 may determine a “failure” as the success/failure of the cyberattack.

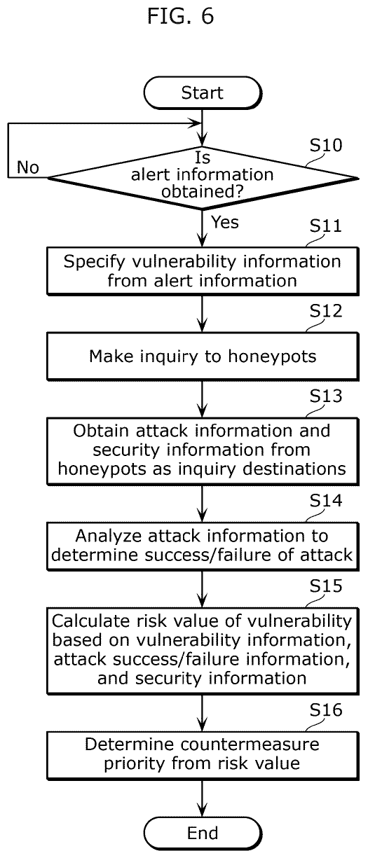

FIG. 6 is a flowchart illustrating an example of a processing operation by priority determination system 10a in the present embodiment.

First, obtainer 11 of priority determination system 10a determines whether obtainer 11 has obtained alert information a1 from vulnerability notification system 30 (step S10). That is, obtainer 11 determines whether a vulnerability found alert has been received. In a case in which obtainer 11 determines that obtainer 11 has not obtained alert information a1 (No in step S10), obtainer 11 repeatedly executes the process of step S10. In a case in which obtainer 11 determines that obtainer 11 has obtained alert information a1 (Yes in step S10), obtainer 11 specifies vulnerability information a2 from alert information a1 (step S11). For example, obtainer 11 specifies vulnerability information a2 included in alert information a1 by extracting vulnerability information a2 from alert information a1. Obtainer 11 then outputs vulnerability information a2 to collaborator 12.

Obtaining vulnerability information a2 from obtainer 11, collaborator 12 makes an inquiry to honeypots 21 (i.e., honeypot processing systems 20) (step S12). As a result, collaborator 12 obtains one or more pieces of attack information a3 and one or more pieces of security information a4 from each of honeypots 21 (i.e., honeypot processing systems 20) as inquiry destinations (step S13). Collaborator 12 then outputs the one or more pieces of attack information a3 and the one or more pieces of security information a4 to attack analyzer 13 together with vulnerability information a2.

Attack analyzer 13 analyzes each of the one or more pieces of attack information a3 to determine the success/failure of a cyberattack on honeypot 21 corresponding to the piece of attack information a3 (step S14). As a result, attack analyzer 13 generates one or more pieces of attack success/failure information a5 indicating the determined success/failure of the cyberattack.

Based on vulnerability information a2 specified in step S12, the one or more pieces of attack success/failure information a5 generated through the process of step S14, and the one or more pieces of security information a4 obtained in step S13, determiner 14 calculates the risk value of the vulnerability indicated in vulnerability information a2 (step S15). The risk value is the above-described risk value after the update. Determiner 14 then determines a countermeasure priority from the risk value after the update (step S16). As a result, priority information a6 is generated by determiner 14 and output to the outside of priority determination system 10a via outputter 15.

As seen from the above, in the present embodiment, a countermeasure priority is determined based on the detail of a cyberattack exploiting a vulnerability of the monitoring target system and the security levels of honeypots 21 receiving the cyberattack. Accordingly, the countermeasure priority can be determined with higher accuracy than a countermeasure priority that is determined based on whether a cyberattack has occurred. That is, it becomes possible to increase the accuracy of a countermeasure priority determined for a vulnerability.

In the present embodiment, in a case in which obtainer 11 obtains alert information a1, collaborator 12 makes an inquiry to honeypots 21 having mutually different security levels. Collaborator 12 thus obtains pieces of attack information a3 and pieces of security information a4 on honeypots 21. Determiner 14 determines a countermeasure priority for a vulnerability for which a notification is made in alert information a1, based on pieces of attack success/failure information a5 and pieces of security information a4 of honeypots 21 as inquiry destinations.

The countermeasure priority for the vulnerability is thus determined in response to obtaining alert information a1, that is, finding the vulnerability in the monitoring target system, as a trigger. In this event, the pieces of attack success/failure information about the found vulnerability and the pieces of security information are collected through the inquiry to honeypots 21 and used to determine the countermeasure priority. That is, a success or a failure of each of cyberattacks and the security levels are used to determine the countermeasure priority. Thus, at the timing when the vulnerability is found, the countermeasure priority for the vulnerability can be determined appropriately with high accuracy.

Specifically, determiner 14 derives an increment for a risk value of a vulnerability, based on pieces of attack success/failure information a5 and pieces of security information a4 of honeypots 21 as the inquiry destinations. Determiner 14 next updates the risk value by adding the derived increment to the risk value associated with the vulnerability. Determiner 14 then determines, as a countermeasure priority for the vulnerability, a higher countermeasure priority as the risk value updated is greater.

Thus, for example, in a case in which the vulnerability is found, a higher countermeasure priority can be determined for the vulnerability as the number of cyberattacks exploiting the vulnerability is larger, the number of successful cyberattacks out of the cyberattacks is larger, or the security levels of honeypots having received the cyberattacks are higher. As a result, the accuracy of the countermeasure priority can be further increased.

In the present embodiment, determiner 14 derives, for each of honeypots 21 as the inquiry destinations, an individual increment corresponding to the combination of attack success/failure information a5 and security information a4 of honeypot 21. Determiner 14 then derives the above-described increment by calculating the sum of the individual increments of honeypots 21. The sum of the individual increments is thus derived as the increment, enabling the derivation of an appropriate increment for the vulnerability.

In the present embodiment, determiner 14 derives, as individual increments, a first individual increment and a second individual increment, which is greater than the first individual increment, as shown in FIG. 3. The first individual increment is an individual increment corresponding to the combination of attack success/failure information a5 indicating that a cyberattack has been a failure and security information a4 indicating a certain security level. Note that the certain security level may be any one of high, middle, or low. The second individual increment is an individual increment corresponding to the combination of attack success/failure information a5 indicating that a cyberattack has been a success and security information a4 indicating the above-described certain security level. Thus, in a case in which attack success/failure information a5 indicates that the cyberattack has been a success, a great individual increment can be derived and reflected in the increment, and in a case in which attack success/failure information a5 indicates that the cyberattack has been a failure, a small individual increment can be derived and reflected in the increment. As a result, an appropriate countermeasure priority that matches the detail of a cyberattack can be determined.

In the present embodiment, determiner 14 derives, as the above-described individual increment corresponding to the combination, a greater individual increment as the security level indicated in security information a4 included in the combination is higher, as shown in FIG. 3. Thus, as the security level of honeypot 21 is higher, a great individual increment can be derived and reflected in the increment. As a result, an appropriate countermeasure priority can be determined.

In the above-described example, alert information a1 transmitted from vulnerability notification system 30 makes the notification of the vulnerability found in the monitoring target system. However, the notification of software including the vulnerability may be made. In this case, collaborator 12 may make an inquiry to honeypot 21 that possesses the software in the notification to obtain attack information a3 and security information a4 from honeypot 21. Alternatively, collaborator 12 may make an inquiry to honeypot 21 to obtain all pieces of attack information a3 stored in attack storage 23 of honeypot processing system 20 including honeypot 21. In this case, collaborator 12 may extract, from all the pieces of attack information a3, a piece of attack information a3 about a cyberattack exploiting the found vulnerability.

### Embodiment 2

In Embodiment 1, priority determination system 10a determines a countermeasure priority for a vulnerability in response to the reception of a vulnerability found alert from vulnerability notification system 30. That is, the vulnerability found alert serves as the trigger to determine the countermeasure priority. A priority determination system in the present embodiment determines a countermeasure priority for a vulnerability each time honeypot 21 receives a cyberattack, without making an inquiry to a plurality of honeypots 21. That is, a cyberattack on honeypot 21 serves as the trigger to determine a countermeasure priority.

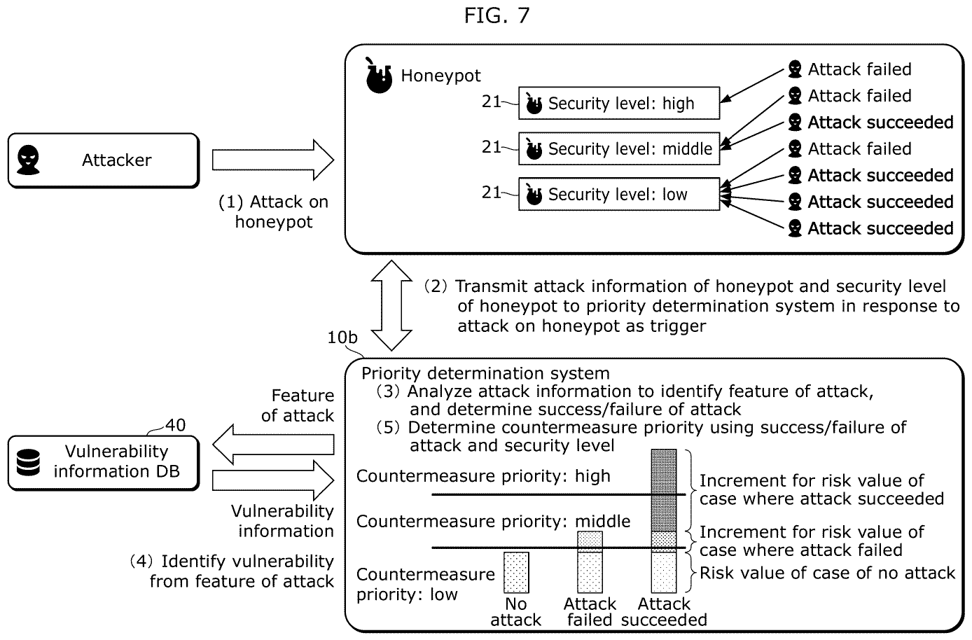

FIG. 7 is a diagram for describing the overview of a processing operation by a priority determination system in the present embodiment.

As with priority determination system 10a in Embodiment 1, priority determination system 10b in the present embodiment is a system that determines, as a countermeasure priority, the priority of countermeasure processing that addresses each of vulnerabilities in a monitoring target system. Priority determination system 10b collaborates with a plurality of honeypots 21.

Each of honeypots 21 includes a software configuration that is identical to at least part of the configuration of the monitoring target system, as in Embodiment 1. The honeypots have mutually different security levels.

In the present embodiment, steps (1) to (5) shown below are executed in order. First, in step (1), an attacker makes a cyberattack on one of honeypots 21. In step (2), attack information a3 indicating the detail of cyberattack on honeypot 21 and security information a4 indicating the security level of honeypot 21 are transmitted to priority determination system 10b. That is, priority determination system 10b receives attack information a3 and security information a4.

In step (3), priority determination system 10b analyzes attack information a3 to identify the feature of the cyberattack on honeypot 21 and further determines a success or a failure of the cyberattack. In step (4), priority determination system 10b identifies a vulnerability associated with the feature of the cyberattack using vulnerability information database 40. Note that the database will also be denoted as a DB. That is, priority determination system 10b obtains, from vulnerability information database 40, vulnerability information a2 that is information for discerning the identified vulnerability.

In step (5), priority determination system 10b determines, as a countermeasure priority, the priority of a countermeasure processing that addresses the vulnerability identified in step (4), using the security level indicated in security information a4 received in step (2) and the success/failure of the cyberattack determined in step (3).

In a specific example of step (5), in a case in which the success/failure of the cyberattack is determined as a “failure”, priority determination system 10b adds an increment for a risk value corresponding to the result of the determination (i.e., the “failure”) to a risk value associated with the identified vulnerability. The risk value is thus updated. Note that the risk value associated with the vulnerability is the risk value immediately before honeypot 21 receives the cyberattack. For example, in a case in which honeypot 21 has never received a cyberattack exploiting the vulnerability, a risk value associated with the vulnerability is a risk value of a case of no attack. In contrast, in a case in which the success/failure of the cyberattack is determined as a “success”, priority determination system 10b adds an increment for a risk value corresponding to the result of the determination (i.e., the “success”) to a risk value associated with the identified vulnerability. The risk value is thus updated. Note that the risk value associated with the vulnerability is the risk value immediately before honeypot 21 receives the cyberattack, as described above. For example, in a case in which honeypot 21 receives a cyberattack exploiting the vulnerability but the cyberattack fails, a risk value associated with the vulnerability is a value obtained by adding an increment of a case of a failure in attack to the risk value of the case of no attack. Note that an increment of the risk value corresponding to a “success” is larger than an increment of the risk value corresponding to a “failure”.

Priority determination system 10b then determines the countermeasure priority “low” in a case in which the risk value after the update is less than or equal to a first threshold, determines the countermeasure priority “middle” in a case in which the risk value after the update is greater than the first threshold and less than or equal to a second threshold, and determines the countermeasure priority “high” in a case in which the risk value after the update is greater than the second threshold, as in Embodiment 1. Note that the second threshold is a value greater than the first threshold.

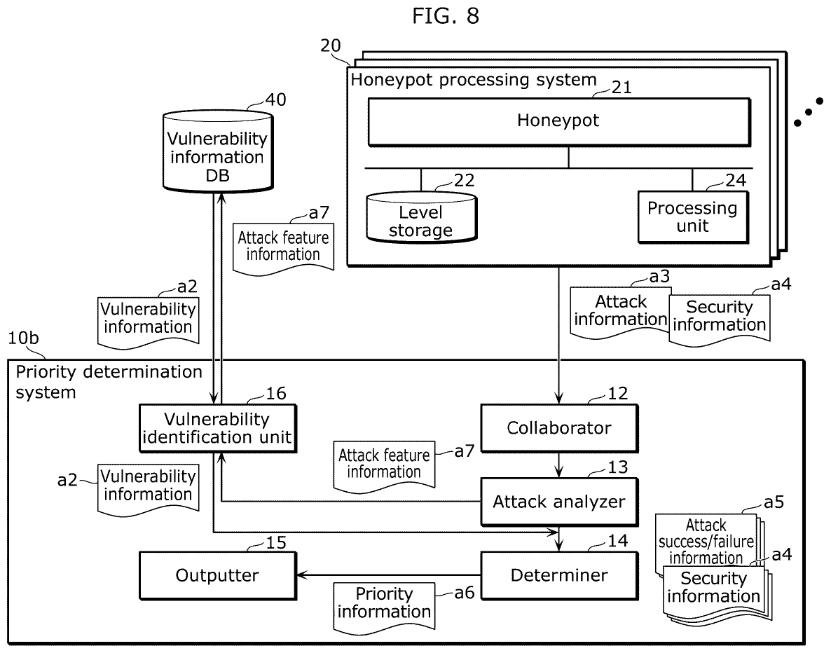

FIG. 8 is a diagram illustrating an example of the functional configuration of priority determination system 10b in the present embodiment.

Priority determination system 10b in the present embodiment includes collaborator 12, attack analyzer 13, determiner 14, outputter 15, and vulnerability identification unit 16.

Collaborator 12 obtains attack information a3 and security information a4 transmitted from honeypot processing system 20 including honeypot 21 that has received a cyberattack, without making an inquiry as in Embodiment 1. Collaborator 12 then outputs attack information a3 and security information a4 to attack analyzer 13. Note that each of honeypot processing systems 20 in the present embodiment need not include attack storage 23 for accumulating pieces of attack information a3. In a case in which honeypot 21 receives a cyberattack, processing unit 24 of honeypot processing system 20 in the present embodiment generates attack information a3 indicating the detail of the cyberattack. Processing unit 24 then transmits security information a4 stored in level storage 22 and attack information a3 having been generated to priority determination system 10b.

In this manner, collaborator 12 in the present embodiment collaborates with honeypot 21 to obtain attack information a3 indicating the detail of a cyberattack on honeypot 21 and security information a4 indicating the security level of honeypot 21, as in Embodiment 1.

Obtaining attack information a3 and security information a4 from collaborator 12, attack analyzer 13 analyzes attack information a3. Specifically, attack analyzer 13 determines whether a cyberattack has been a success or a failure, that is, the success/failure of the cyberattack, based on the detail of the cyberattack indicated in attack information a3. Attack analyzer 13 then generates information indicating the success/failure of the cyberattack determined through the analysis of attack information a3, as attack success/failure information a5. Further, based on the detail of the cyberattack indicated in attack information a3, attack analyzer 13 identifies the feature of the cyberattack and generates attack feature information a7 indicating the identified feature of the cyberattack. That is, attack analyzer 13 in the present embodiment analyzes attack information a3 to generate attack success/failure information a5 indicating whether the cyberattack has been a success or a failure and generates attack feature information a7 indicating the feature of the cyberattack. Note that the feature of the cyberattack includes, for example, discerning information on software that is included in honeypot 21 and has received the cyberattack, and the method of the cyberattack on the software.

Attack analyzer 13 then outputs attack feature information a7 to vulnerability identification unit 16. This causes vulnerability identification unit 16 to output vulnerability information a2 corresponding to attack feature information a7 to determiner 14. Vulnerability information a2 is information for discerning the vulnerability that is associated in advance with the feature of the cyberattack indicated in attack feature information a7. Attack analyzer 13 further outputs attack success/failure information a5 and security information a4 to determiner 14.

Obtaining attack feature information a7 from attack analyzer 13, vulnerability identification unit 16 outputs attack feature information a7 to vulnerability information database 40. Vulnerability information database 40 retains, for each feature of a cyberattack, data that indicates a vulnerability in association with the feature. Obtaining attack feature information a7 from vulnerability identification unit 16, vulnerability information database 40 searches the data for a vulnerability associated with the feature of the cyberattack indicated in attack feature information a7. Vulnerability information database 40 thereafter outputs vulnerability information a2 that is information for discerning the vulnerability obtained in the searching to vulnerability identification unit 16. As a result, vulnerability identification unit 16 obtains vulnerability information a2 corresponding to attack feature information a7. That is, vulnerability identification unit 16 identifies the vulnerability corresponding to the feature of the cyberattack indicated in attack feature information a7, using vulnerability information database 40. In this manner, vulnerability identification unit 16 in the present embodiment identifies, based on attack feature information a7, the vulnerability exploited for the cyberattack. Vulnerability identification unit 16 then outputs the identified vulnerability, that is, vulnerability information a2, to determiner 14.

Determiner 14 obtains attack success/failure information a5 and security information a4 from attack analyzer 13 and obtains vulnerability information a2 from vulnerability identification unit 16. Determiner 14 then determines a countermeasure priority that is the priority of countermeasure processing that addresses the vulnerability indicated in vulnerability information a2. In this determination, determiner 14 derives an individual increment using the success/failure of the cyberattack indicated in attack success/failure information a5 and the security level indicated in security information a4 corresponding to attack success/failure information a5. That is, determiner 14 derives the individual increment as in Embodiment 1. Determiner 14 then updates a risk value associated with the vulnerability indicated in vulnerability information a2 by adding the calculated individual increment to the risk value. Determiner 14 determines the countermeasure priority by comparing the risk value after the update with the first threshold and the second threshold, as in Embodiment 1. Determiner 14 generates priority information a6 that indicates the determined countermeasure priority and the above-described vulnerability in association with each other and outputs priority information a6 to outputter 15.

In this manner, determiner 14 in the present embodiment determines, based on attack information a3 and security information a4, a countermeasure priority that is the priority of countermeasure processing addressing a vulnerability of the monitoring target system that has been exploited for a cyberattack, as in Embodiment 1.

Obtaining priority information a6 described above from determiner 14, outputter 15 outputs priority information a6 to the outside of priority determination system 10b. That is, outputter 15 in the present embodiment outputs the determined countermeasure priority.

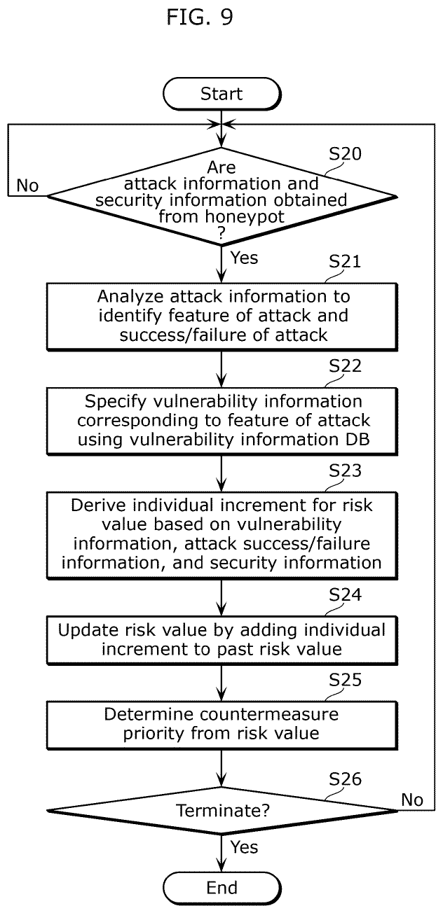

FIG. 9 is a flowchart illustrating an example of a processing operation by priority determination system 10b in the present embodiment.

First, collaborator 12 of priority determination system 10b determines whether attack information a3 and security information a4 are obtained from honeypot 21 (i.e., honeypot processing system 20) (step S20). That is, at the timing when honeypot 21 receives a cyberattack, collaborator 12 determines whether attack information a3 and security information a4 about the cyberattack and honeypot 21, respectively, are obtained.

In a case in which collaborator 12 determines that attack information a3 and security information a4 are not obtained (No in step S20), collaborator 12 repeatedly executes the process of step S20. In a case in which collaborator 12 determines that attack information a3 and security information a4 are obtained (Yes in step S20), collaborator 12 outputs attack information a3 and security information a4 to attack analyzer 13. Attack analyzer 13 analyzes attack information a3 to identify the feature and success/failure of the cyberattack (step S21). As a result, attack analyzer 13 generates attack feature information a7 and attack success/failure information a5 and outputs attack feature information a7 to vulnerability identification unit 16.

Vulnerability identification unit 16 specifies vulnerability information a2 associated with the feature of the cyberattack indicated in attack feature information a7, using vulnerability information database 40 (step S22). Vulnerability identification unit 16 then outputs specified vulnerability information a2 to determiner 14.

Based on vulnerability information a2 specified in step S22, attack success/failure information a5 generated through the process of step S21, and security information a4 obtained in step S20, determiner 14 derives an individual increment for the risk value of the vulnerability indicated in vulnerability information a2 (step S23). Determiner 14 further updates a past risk value associated with the vulnerability indicated in vulnerability information a2 by adding the derived individual increment to the past risk value (step S24). Determiner 14 then determines a countermeasure priority from the risk value after the update (step S25). As a result, priority information a6 is generated by determiner 14 and output to the outside of priority determination system 10b via outputter 15.

Next, priority determination system 10b determines whether to terminate the process for determining the countermeasure priority (step S26). Here, in a case in which priority determination system 10b determines to terminate the process (Yes in step S26), priority determination system 10b terminates the process. In a case in which priority determination system 10b determines not to terminate the process (No in step S26), priority determination system 10b repeatedly executes the processes starting from step S20.

As seen from the above, in the present embodiment also, a countermeasure priority is determined based on the detail of a cyberattack exploiting a vulnerability of the monitoring target system and the security levels of honeypots 21 receiving the cyberattack, as in Embodiment 1. Accordingly, the countermeasure priority can be determined with higher accuracy than a countermeasure priority that is determined based on whether a cyberattack has occurred. That is, it becomes possible to increase the accuracy of a countermeasure priority determined for a vulnerability.

In the present embodiment, for each of honeypots 21 having the mutually different security levels, each time honeypot 21 receives the cyberattack, attack information a3 and security information a4 of honeypot 21 are transmitted to collaborator 12. In this case, each time collaborator 12 obtains attack information a3 and security information a4, determiner 14 determines the countermeasure priority for the vulnerability identified by vulnerability identification unit 16, based on security information a4 and attack success/failure information a5 generated from attack information a3.

Thus, the obtaining of attack information a3 and security information a4 by collaborator 12, that is, the reception of a cyberattack by honeypot 21, serves as a trigger to determine a countermeasure priority for the vulnerability exploited for the cyberattack. In this event, attack success/failure information a5 about the vulnerability exploited for the cyberattack and security information a4 are used to determine the countermeasure priority. That is, a success or a failure of the cyberattack and the security level are used to determine the countermeasure priority. Thus, at the timing when honeypot 21 receives the cyberattack, the countermeasure priority for the vulnerability exploited for the cyberattack can be determined appropriately with high accuracy.

Specifically, each time collaborator 12 obtains attack information a3 and security information a4, determiner 14 derives an individual increment for the risk value of the above-described vulnerability, based on attack success/failure information a5 and security information a4. Determiner 14 next updates the risk value by adding the derived individual increment to the most recent risk value associated with the vulnerability. Determiner 14 then determines, as a countermeasure priority for the vulnerability, a higher countermeasure priority as the risk value updated is greater.

Thus, each time honeypot 21 receives a cyberattack, for example, in a case in which the security level of honeypot 21 is high and the cyberattack has been a success, a high countermeasure priority can be determined for a vulnerability exploited for the cyberattack. As a result, the accuracy of the countermeasure priority can be further increased.

In the present embodiment, determiner 14 derives a greater individual increment for a first case than for a second case, as shown in FIG. 3. The first case is a case in which attack success/failure information a5 indicates that a cyberattack has been a success and security information a4 indicates a certain security level. Note that the certain security level may be any one of high, middle, or low. The second case is a case in which attack success/failure information a5 indicates that a cyberattack has been a failure and security information a4 indicates the above-described certain security level. Thus, in a case in which attack success/failure information a5 indicates that the cyberattack has been a success, a great individual increment can be derived and reflected in a risk value, and in a case in which attack success/failure information a5 indicates that the cyberattack has been a failure, a small individual increment can be derived and reflected in the risk value. As a result, an appropriate countermeasure priority that matches the detail of a cyberattack can be determined.

In the present embodiment, determiner 14 derives a greater individual increment as the security level indicated in security information a4 is higher, as shown in FIG. 3. Thus, as the security level of honeypot 21 is higher, a great individual increment can be derived and reflected in a risk value. As a result, an appropriate countermeasure priority can be determined.

As seen from the above, the priority determination system according to one or more aspects has been described based on Embodiments 1 and 2. However, the present disclosure is not limited to these embodiments. Various modifications of Embodiment 1 or 2 that are conceivable by those skilled in the art and modes formed by combining constituent components described in different embodiments may be included in the present disclosure without departing from the scope of the present disclosure.

For example, attack analyzer 13 may identify a security countermeasure implemented in software that blocks a cyberattack, by analyzing attack information a3. Then, attack analyzer 13 may output information indicating the security countermeasure from outputter 15. The security countermeasure is a countermeasure that is recommended as countermeasure processing that addresses the vulnerability indicated in vulnerability information a2.

Note that, in Embodiments 1 and 2 described above, one honeypot 21 of honeypots 21 may have a software configuration that includes the software configuration of the monitoring target system including security-related configurations, and the security level of the one honeypot 21 may be set at the highest level.

Note that, in Embodiments 1 and 2 described above, each of honeypots 21 is a honeypot that has a software configuration identical to at least part of a software configuration of the monitoring target system excluding some or all of security-related configurations, and the security level of the honeypot may be determined in accordance with the excluded security-related configurations. At this time, in each honeypot 21, the excluded security-related configurations may be determined in order from closest to an entry point, and the security level may be determined in accordance with the number of excluded security-related configurations and the number of stages from the entry point.

Note that each of the elements in the foregoing embodiments may be configured in the form of an exclusive hardware product, or may be realized by executing a software program suitable for such element. Each of the elements may be realized by means of a program executing unit, such as a central processing unit (CPU) and a processor, reading and executing the software program recorded on a recording medium such as a hard disk or a semiconductor memory. Here, the software program that realizes the foregoing priority determination system and others is a computer program for causing a computer to execute the steps in the flowcharts shown in FIG. 6 and FIG. 9.

Note that the present disclosure also includes the cases described below.
(1) At least one of the foregoing system or device is, more specifically, a computer system that includes a microprocessor, a read-only memory (ROM), a random access memory (RAM), a hard disk unit, a display unit, a keyboard, a mouse, etc. The RAM or the hard disk unit stores the computer program. The microprocessor's operating in accordance with the computer program enables at least one of the foregoing device to achieve its function. Here, the computer program is configured, using a combination of a plurality of command codes representing instructions given to the computer to achieve a predetermined function.
(2) One or more, or all of the elements included in at least one of the foregoing system or device may be configured in the form of a single system large scale integration (LSI). The system LSI is a super-multifunctional LSI that is manufactured by integrating a plurality of elements onto a single chip. The system LSI is, more specifically, a computer system that is configured by including a microprocessor, a ROM, a RAM, etc. The RAM stores the computer program. The microprocessor's operating in accordance with the computer program enables the system LSI to achieve its function.
(3) One or more, or all of the elements included in at least one of the foregoing system or device may be implemented in the form of an integrated circuit (IC) card or a single module which is removable from the device. The IC card or the module is a computer system that includes a microprocessor, a ROM, a RAM, etc. The IC card or the module may include the foregoing super-multifunctional LSI. The microprocessor's operating in accordance with the computer program enables the IC card or the module to achieve its function. Such IC card or the module may be tamper resistant.
(4) The present disclosure may be the methods described above. The present disclosure may also be a computer program that enables such methods to be implemented by means of a computer, or digital signals that form a computer program.

The present disclosure may be configured by means of recording a computer program or digital signals on a computer-readable recording medium such as a flexible disk, a hard disk, a compact disc (CD)-ROM, a digital versatile disc (DVD), a DVD-ROM, a DVD-RAM, a Blu-ray(registered trademark) disc (BD), and a semiconductor memory. The present disclosure may also be digital signals recorded in such recording medium.

The present disclosure may be configured by means of transmitting the computer program or the digital signals via, for example, a telecommunication line, a wireless or wired communication line, a network represented by the Internet, or data broadcasting.

The present disclosure may be implemented by means of transmitting the program or the digital signals recorded on a recording medium or transmitting the program or the digital signals via, for example, a network, thereby enabling another independent computer system to carry out the present disclosure.

### Further Information About Technical Background to this Application

The disclosure of the following patent application including specification, drawings, and claims is incorporated herein by reference in their entirety: Japanese Patent Application No. 2025-054017 filed on Mar. 27, 2025.

### Industrial Applicability

The priority determination system according to the present disclosure is applicable to, for example, a device or system that determines a priority for a vulnerability, for example, in an ECU or the like to be built in a vehicle.

1. A priority determination system comprising:
a processor; and
a memory coupled to the processor,
wherein, using the memory, the processor:
collaborates with a honeypot to obtain attack information indicating a detail of a cyberattack on the honeypot and security information indicating a security level of the honeypot, the honeypot including a software configuration that is identical to at least part of a configuration of a monitoring target system;
determines, based on the attack information and the security information, a countermeasure priority that is a priority of countermeasure processing that addresses a vulnerability in the monitoring target system, the vulnerability having been exploited for the cyberattack; and
outputs the countermeasure priority determined.

2. The priority determination system according to claim 1, wherein
the processor further:
obtains alert information for notification of the vulnerability found in the monitoring target system; and
analyzes the attack information to generate attack success/failure information indicating whether the cyberattack has been a success or a failure, wherein
in the collaboration, when the processor obtains the alert information, the processor makes an inquiry to a plurality of honeypots having mutually different security levels to obtain the attack information and the security information of each of the plurality of honeypots, the plurality of honeypots each being the honeypot, and
in the determination, the processor determines the countermeasure priority for the vulnerability for which the notification is made in the alert information, based on the attack success/failure information and the security information of each of the plurality of honeypots as inquiry destinations.

3. The priority determination system according to claim 2, wherein
in the determination, the processor:
derives an increment for a risk value of the vulnerability, based on the attack success/failure information and the security information of each of the plurality of honeypots as the inquiry destinations;
updates the risk value by adding the increment derived to the risk value associated with the vulnerability; and
determines, as the countermeasure priority for the vulnerability, a higher countermeasure priority as the risk value updated is greater.

4. The priority determination system according to claim 3, wherein
in the determination, the processor:
derives, for each of the plurality of honeypots as the inquiry destinations, an individual increment corresponding to a combination of the attack success/failure information and the security information of the honeypot; and
derives the increment by calculating a sum of the individual increments of the plurality of honeypots.

5. The priority determination system according to claim 4, wherein
in the determination, the processor derives a first individual increment and a second individual increment each being the individual increment, the second individual increment being greater than the first individual increment,
the first individual increment is the individual increment corresponding to a combination of (i) the attack success/failure information indicating that the cyberattack has been a failure and (ii) the security information indicating a certain security level, and
the second individual increment is the individual increment corresponding to a combination of (i) the attack success/failure information indicating that the cyberattack has been a success and (ii) the security information indicating the certain security level.

6. The priority determination system according to claim 4, wherein
in the determination, the processor derives, as the individual increment corresponding to the combination, a greater individual increment as the security level indicated by the security information included in the combination is higher.

7. The priority determination system according to claim 1, wherein
the processor further:
analyzes the attack information to generate (i) attack success/failure information indicating whether the cyberattack is a success or a failure and (ii) attack feature information indicating a feature of the cyberattack; and
identifies, based on the attack feature information, the vulnerability exploited for the cyberattack, wherein
when, for each of the plurality of honeypots having the mutually different security levels, the attack information and the security information of the honeypot are transmitted to the processor each time the honeypot receives the cyberattack,
in the determination, each time the processor obtains the attack information and the security information, the processor determines the countermeasure priority for the vulnerability identified by the processor, based on the security information and the attack success/failure information generated from the attack information.

8. The priority determination system according to claim 7, wherein
in the determination, each time the processor obtains the attack information and the security information, the processor:
derives an individual increment for a risk value of the vulnerability, based on the security information and the attack success/failure information generated from the attack information;
updates the risk value by adding the individual increment derived to a most recent risk value associated with the vulnerability; and
determines, as the countermeasure priority for the vulnerability, a higher countermeasure priority as the risk value updated is greater.

9. The priority determination system according to claim 8, wherein
in the determination, the processor derives the individual increment to be greater in a first case than in a second case,
the first case is a case in which the attack success/failure information indicates that the cyberattack has been a success and the security information indicates a certain security level, and
the second case is a case in which the attack success/failure information indicates that the cyberattack has been a failure and the security information indicates the certain security level.

10. The priority determination system according to claim 8, wherein
in the determination, the processor derives, as the individual increment, a greater individual increment as the security level indicated by the security information is higher.

11. A priority determination method that is executed by a computer, the priority determination method comprising:
collaborating with a honeypot to obtain attack information indicating a detail of a cyberattack on the honeypot and security information indicating a security level of the honeypot, the honeypot including a software configuration that is identical to at least part of a configuration of a monitoring target system;
determining, based on the attack information and the security information, a countermeasure priority that is a priority of countermeasure processing that addresses a vulnerability in the monitoring target system, the vulnerability having been exploited for the cyberattack; and
outputting the countermeasure priority determined.
